(19) United States
(12) Patent Application Publication
(10) Pub. No.: US 2005/0048810 A1
(43) Pub. Date: Mar. 3, 2005

(54) Membrane switch with J-tail lead

(76) Inventors: David Malcolm Howie, Foxborough, MA (US); David Matthew Holscher, Salisbury, MA (US); Earl Alfred Picard JR., Portsmouth, NH (US)

Correspondence Address: QUARLES & BRADY LLP, 411 E. WISCONSIN AVENUE, SUITE 2040, MILWAUKEE, WI, 53202-4497, US

(21) Appl. No.: 10/923,989

(22) Filed: Aug. 23, 2004

Related U.S. Application Data
(60) Provisional application No. 60/497,595, filed on Aug. 25, 2003.

(51) Int. Cl. H01R 12/00

(52) U.S. Cl. 439/67

(57) ABSTRACT

A J-tail construction of a flexible interconnect between a membrane switch and auxiliary circuit boards allows for the elimination of an electrical joint between the membrane switch and the connector for circuit board orientations desirable in appliance manufacture.

### CROSS-REFERENCE TO RELATED APPLICATIONS

This application claims the benefit of U.S. Provisional Application 60/497,595 filed Aug. 25, 2003 hereby incorporated by reference.

### STATEMENT REGARDING FEDERALLY SPONSORED RESEARCH OR DEVELOPMENT

--

### BACKGROUND OF THE INVENTION

The present invention relates to membrane switches and in particular to an interconnection method useful for connecting membrane switches to other circuit elements.

Membrane switches provide pairs of electrical contacts facing each other across opposed surfaces of spaced apart flexible membranes. Normally, the contacts are held in separation by a spacer layer and the natural elasticity of the membranes. Pressure on a front membrane, deforming the membrane inward toward a rear membrane, may cause the contacts to touch providing for a switching of electrical current.

A flexible graphic fascia layer printed with button outlines may be adhered to the front face of the membrane switch and provides a continuous surface resistant to environmental contamination. For this reason, membrane switches are popular in many appliances where the surfaces of the switches may be splashed with liquid or washed during normal use.

In a typical appliance, the membrane switch will be electrically connected by means of a wiring harness to a circuit board providing control functions for the appliance. The circuit board normally positioned behind the membrane switch in the limited space provided by the appliance housing, is usually formed of a rigid material amendable to standard printed circuit board manufacturing and assembly techniques. This is in contrast to the flexible circuit material of the membrane switch.

Referring to FIG. 2, it is known in the art to use a flexible circuit strip 10 to connect the membrane switch 12 to the auxiliary circuit board 14 thereby avoiding the expense of discrete wiring. The flexible circuit strip 10 has a series of parallel conductors 16 exposed along one surface of a flexible insulating substrate and may be constructed using well known materials and techniques including, but not limited to, printing and etching fabrication methods.

One end of the flexible circuit strip 10 may be attached to the membrane switch 12 and the other end received by an electrical connector 20 on the auxiliary circuit board 14 allowing the latter to be disconnected for manufacturing and repair.

In a common appliance configuration, conductors 22 of the membrane switch 12 will be exposed on a front face of the rear membrane of the membrane switch 12 toward the user, and the electrical connector 20 on the circuit board 14 will open rearward from the circuit board 14 to connect with the parallel conductors 16 of the flexible circuit strip 10 on a lower side of the electrical connector 20. These orientations, desirable for reasons of manufacture and access to the electrical connector 20, require that the parallel conductors 16 of the flexible circuit strip 10 be connected to the conductors 22 of the membrane switch 12 in a face-to-face abutment. One method of making such a connection is by means of a “z-axis” adhesive which conducts electricity predominantly through rather than along the adhesive interface. The z-axis adhesive allows multiple parallel conductors 16 to be electrically connected with corresponding aligned conductors 22 without shorting between parallel conductors 16 or conductors 22.

This use of a z-axis epoxy adhesive increases the manufacturing complexity. Further, z-axis adhesives can be unreliable and by leaving a small gap between the flexible circuit strip 10 and the membrane switch 12 can promote a capillary attraction that draws moisture into the interface and degrades the electrical connection.

### BRIEF SUMMARY OF THE INVENTION

The present invention provides a flexible connector strip with a “J-tail” construction in which the flexible connector strip doubles back along its length while remaining in a plane of the flexible conductor strip. The J-tail effects a change of direction of the conductors without inverting the conductors. This in turn allows the flexible conductive strip to be a simple continuation of the flexible material of the membrane switch eliminating the need for a z-axis adhesive bond.

Specifically the present invention provides an electrical interconnection system in which a flexible circuit providing conductors of a membrane switch may communicate with a circuit board having a connector. A flexible circuit strip has a first end attached to the flexible circuit and a second end receivable by the connector of the circuit board, the second end of the flexible circuit strip including a portion doubling back along the flexible circuit strip within a plane of the flexible circuit strip before being received by the connector on the circuit board.

It is thus an object of at least one embodiment of the invention to provide an improved flexible circuit strip to interconnect membrane switches with associated circuit board.

The flexible circuit strip may be a continuation of a flexible circuit forming part of the membrane switch and integral therewith. The same conductors of the flexible circuit may extend onto the flexible circuit strip.

Thus it is therefore another object of at least one embodiment of the invention to provide a flexible circuit strip that prevents the need for a z-axis adhesive bond between the flexible circuit strip and conductors of the membrane switch. The invention may also eliminate the need for through-hole connections.

The connector may include contacts contacting conductors on a surface of the flexible circuit strip.

It is thus another object of at least one embodiment of the invention to provide a system that works with a connector that may directly receive the flexible circuit strip.

The connector may include contacts contacting conductors on an outer surface of the flexible circuit strip.

It is thus another object of at least one embodiment of the invention to allow convenient orientation of the membrane switch, the circuit board and the connector to allow the use of standard assembly techniques, connectors, and orientations of circuit boards.

These particular objects and advantages may apply to only some embodiments falling within the claims and thus do not define the scope of the invention.

### BRIEF DESCRIPTION OF THE DRAWINGS

FIG. 1 is a simplified perspective view of an appliance showing a membrane switch exposed on a front door of the appliance such as may form part of the present invention;

FIG. 2 is a perspective view of a prior art interconnection system for a membrane switch auxiliary circuit board using a z-axis adhesive as described above in the Background of the Invention;

FIG. 3 is an exploded perspective view of an interconnection system of the present invention showing a J-tail flexible circuit strip such as eliminates the need for a z-axis adhesive;

FIG. 4 is a cross-section along lines 4—4 of FIG. 3 showing connections between conductors on the flexible circuit strip and the conductors of the circuit board; and

FIG. 5 is a perspective view of the underside of the strip of FIG. 3 showing surface mounted parallel conductors.

### DETAILED DESCRIPTION OF THE PREFERRED EMBODIMENT

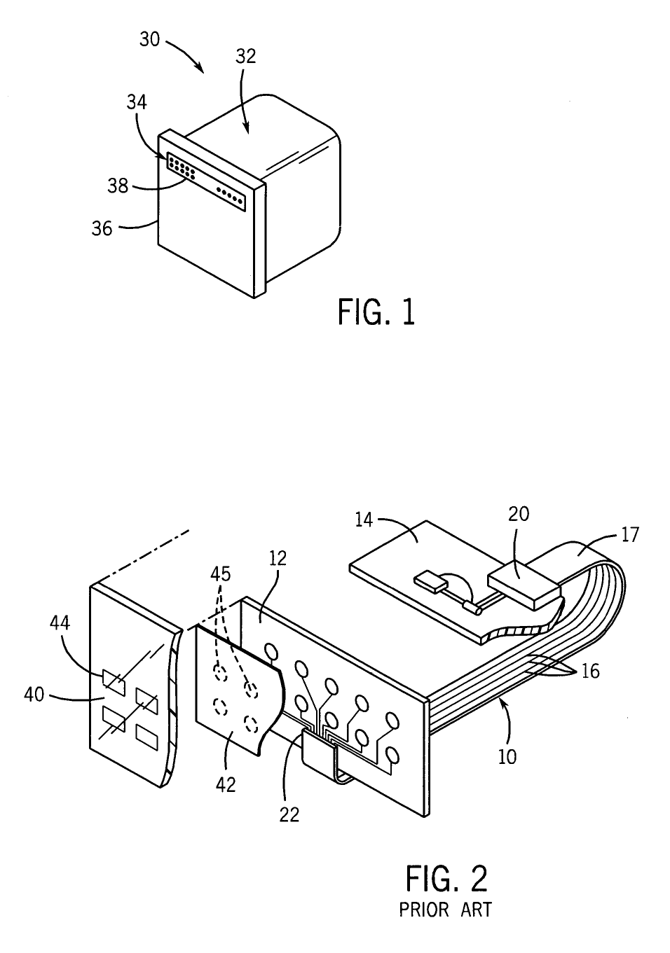

Referring to FIG. 1, an appliance 30 such as a dishwasher may include a housing 32 having a console area 34, in this case the front of a door 36, visible and accessible to a user of the appliance 30. A membrane switch 38 may be positioned with a front face exposed to the user of the appliance 30 at the console area 34 so as to be operable by the user. Alternatively, the membrane switch 38 can be located on a surface not visible by the operator once the appliance is in use—for example—on the top of the door which is ultimately hidden by the countertop when the appliance is installed.

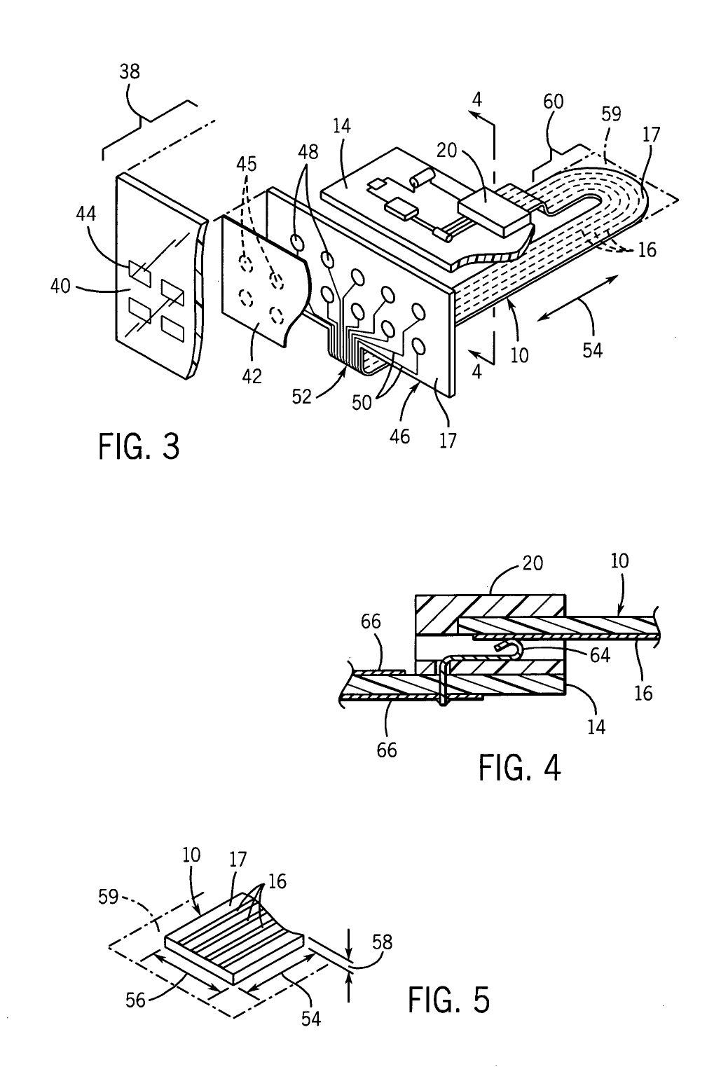

Referring now to FIG. 3, the membrane switch 38 is composed of a transparent graphic layer 40, through whose front surface may be visible button indicia 44 printed on the rear of the graphic layer 40. The graphic layer 40 covers a front membrane 42 on whose rear surface may be placed shorting pads 45 as is understood in the art. A spacer layer (not shown) is positioned between the front membrane 42 and a rear membrane 46, the latter having on its front surface interdigitated contact fingers 48 of a type well known in the art. The rear membrane 46 is flexible and provides a circuit with a flexible insulating substrate 17 supporting on its front face electrical conductors 50 communicating from the interdigitated contact fingers 48 to a lower edge of the rear membrane 46.

As will be understood to those of ordinary skill in the art, the interdigitated contact fingers 48 and conductors 50 may be printed of conductive inks or the like or created using subtractive etching techniques, and are shown in simplified form in FIG. 3 in which the interdigitation and separate conductors for each of the finger pairs is not depicted.

The flexible insulating substrate 17 of the rear membrane 46 may continue downward in a tab 52, then bend rearward to provide the basis of the flexible circuit strip 10. It will be understood, therefore, that the rear membrane 46 and flexible circuit strip 10 may share a common insulating substrate 17 and be manufactured together as an integral unit with conductors 50 becoming parallel conductors 16 exposed on a lower outer face of the flexible circuit strip 10.

Referring now to FIGS. 3 and 5, the flexible circuit strip 10 extends generally along a length 54 from the rear membrane 46 to the auxiliary circuit board 14 and the parallel conductors 16 run along that length and are spaced apart from each other across the width 56 of the flexible circuit strip 10. The thickness 58 of the flexible circuit strip 10 is limited to provide flexibility. The width 56 and length 54 together define the plane 59 of the flexible circuit strip 10 being a two-dimensional planar or non-planar.

Referring again to FIG. 3, the flexible circuit strip 10 in the present invention includes a J-tail section 60 in which the flexible circuit strip 10 curves back upon itself within the plane 59 of the flexible circuit strip 10 in contrast to the out-of-plane curvature shown in FIG. 2. As used herein, in-plane curvature is instantaneous curvature about an axis that is generally perpendicular to the instantaneous plane 59 of the flexible circuit strip 10, whereas the out-of-plane curvature is instantaneous curvature about an axis that is generally parallel to the instantaneous plane 59 of the flexible circuit strip 10. In the preferred embodiment, the J-tail section 60 provides two (2) parallel legs of the “J” so that the parallel conductors reverse direction by 180 degrees to be accepted by the rearwardly opening electrical connector 20. In the J-tail section 60, the parallel conductors 16 remain on the lower or outer surface of the flexible circuit strip 10.

Referring now to FIG. 4, the parallel conductors 16 on the lower surface of the flexible circuit strip 10 contact flexible fingers 64 contained within the shell of electrical connector 20 when the end of the flexible circuit strip 10 is inserted into the opening of the electrical connector 20. The flexible fingers 64 extend upward from the shell of the electrical connector 20 and extend downward through the shell of connector 20 to join conductive traces 66 on the bottom or top of the circuit board 14.

Referring to FIG. 3, it will be understood to one of ordinary skill in the art, that the J-tail section 60 need not be planar but may, for example, have one or both legs curved out-of-plane to allow the circuit board 14 to be oriented at alternative angles as necessary. The term J-tail has been adopted herein for descriptive simplicity, but the present invention should not be considered to be limited (beyond as stated in the claims) to a connector strip that necessarily resembles a letter J.

It is specifically intended that the present invention not be limited to the embodiments and illustrations contained herein, but include modified forms of those embodiments including portions of the embodiments and combinations of elements of different embodiments as come within the scope of the following claims.

1. An electrical interconnection system comprising:
a flexible circuit providing conductors of a membrane switch;
a circuit board requiring electrical interconnection with the flexible circuit, the circuit board having an electrical connector; and
a flexible circuit strip having a first end attached to the flexible circuit and a second end receivable by the connector of the circuit board, the second end of the flexible circuit strip including a portion doubling back along the flexible circuit strip within a plane of the flexible circuit strip before being received by the connector of the circuit board.

2. The electrical interconnection system of claim 1 wherein the flexible circuit strip has an insulating substrate that is a continuation of an insulating substrate of the flexible circuit of the membrane switch and integral therewith.

3. The electrical interconnection system of claim 2 wherein conductors of the first circuit card continue onto the flexible circuit strip.

4. The electrical interconnection system of claim 1 wherein the connector includes contacts contacting conductors on a surface of the flexible circuit strip.

5. The electrical interconnection system of claim 1 wherein the flexible circuit strip provides a set of substantially parallel conductors on a face of the flexible circuit strip.

6. A circuit board system comprising:
a flexible circuit having a front face supporting electrical conductors of a membrane switch;
a circuit board positioned behind the flexible circuit;
a flexible circuit strip having a first end attached to the flexible circuit and extending rearward from the flexible circuit, the flexible circuit strip providing a continuous path of conductors from the front face of the flexible circuit along the rearwardly extending flexible circuit strip to be exposed outwardly as the flexible circuit strip extends rearwardly, a second end of the flexible circuit strip including a portion doubling back along the flexible circuit strip within a plane of the flexible circuit strip; and
an electrical connector communicating with the electrical conductors of the circuit board.

7. The electrical interconnection system of claim 6 wherein the connector receives the flexible circuit strip from a rear direction.

8. The electrical interconnection system of claim 6 wherein the connector has contacts facing inwardly to oppose the outwardly facing conductors of the flexible circuit strip.

9. The electrical interconnection system of claim 6 wherein the flexible circuit strip has an insulating substrate that is a continuation of an insulating substrate of the flexible circuit and integral therewith.

10. The electrical interconnection system of claim 9 wherein conductors of the flexible circuit continue onto the flexible circuit strip.

11. The electrical interconnection system of claim 6 wherein the connector includes contacts contacting parallel conductors on a surface of the flexible circuit strip.

12. The electrical interconnection system of claim 6 wherein the flexible circuit strip provides a set of substantially parallel conductors on a face of the flexible circuit strip.

13. The electrical interconnection system of claim 6 wherein a plane of the front face is substantially vertical and the plane of the flexible circuit strip is substantially horizontal.

14. An appliance comprising:
a console supporting a membrane switch for operation by a user, the membrane switch including a flexible circuit having a front face supporting electrical conductors;
a circuit board positioned behind the flexible circuit and extending in a plane away from a plane of the front face and supporting electrical conductors and an electrical connector receiving connections at a rear of the circuit board;
a flexible circuit strip having a first end attached to the flexible circuit and a second end including a portion doubling back along the flexible circuit strip within a plane of the flexible circuit strip to be received by the connector.

15. The electrical interconnection system of claim 14 wherein the connector provided contacts on a lower side of the connector for contacting conductors on a lower side of the flexible circuit strip.

16. The electrical interconnection system of claim 14 wherein the flexible circuit strip has an insulating substrate that is a continuation of an insulating substrate of the flexible circuit and integral therewith.

17. The electrical interconnection system of claim 16 wherein conductors of the flexible circuit continue onto the flexible circuit strip.

18. The electrical interconnection system of claim 14 wherein the flexible circuit strip provides a set of substantially parallel conductors on a face of the flexible circuit strip.
